(19) United States
(12) Patent Application Publication
(10) Pub. No.: US 2011/0018376 A1
(43) Pub. Date: Jan. 27, 2011

(54) BUSBAR TERMINAL, BUSBAR UNIT, AND MOTOR

(75) Inventors: Nakaba Kataoka, Kyoto (JP); Keita Nakanishi, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Kyoto (JP)

(21) Appl. No.: 12/921,782

(22) PCT Filed: Mar. 12, 2009
(86) PCT No.: PCT/JP2009/054801

§ 371 Date: Sep. 10, 2010

(30) Foreign Application Priority Data
Mar. 13, 2008 (JP) 2008-063623

(51) Int. Cl. H02K 11/00

(52) U.S. Cl. 310/71

(57) ABSTRACT

A technique and structure for establishing a sufficient electrical connection between an armature and a power supply of a motor even for use in severe working environments through at least one busbar is such that each of the at least one busbar is connected a conductor wire arranged to supply a drive current to the armature of the motor. The structure includes a terminal plate having a through hole defined therein to allow the conductor wire to pass therethrough, and a terminal wall arranged to rise above the terminal plate from a periphery of the through hole.

### BACKGROUND OF THE INVENTION

1. Field of the Invention

The present invention relates to technology concerning busbar terminals arranged to electrically connect an armature and a power supply of a motor to each other.

2. Description of the Related Art

In recent years, busbar units used to supply a drive current to an armature of a motor have been proposed. Such busbar units are used to electrically connect an armature and a power supply of a motor to each other.

JP-UM-B 2-005647, for example, shows a conventional busbar unit of the type as described above. JP-UM-B 2-005647 discloses a busbar unit provided with busbar terminals and further teaches a technique of connecting a conductor wire arranged on an armature of a motor and a hook portion of each busbar terminal to each other through a fusing method.

However, in the above described conventional method, when the motor is placed in severe usage conditions, such as in a high-vibration environment, the hook portion of such a busbar terminal and the conductor wire provided on the armature of the motor will become disconnected.

### SUMMARY OF THE INVENTION

A busbar terminal according to a preferred embodiment of the present invention is preferably a busbar terminal to which is connected a conductor wire arranged to supply a drive current to an armature of a motor, the busbar terminal including a terminal plate having a through hole defined therein to allow the conductor wire to pass therethrough, and a terminal wall arranged to rise above the terminal plate from a periphery of the through hole.

In addition, a busbar unit according to an example of a preferred embodiment of the present invention is provided with the busbar terminal.

Furthermore, a motor according to an example of a preferred embodiment of the present invention is provided with the busbar unit.

The busbar terminal according to an example of a preferred embodiment of the present invention is capable of ensuring a wide area for connection with the conductor wire.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic side cross-sectional view of a brushless motor according to an example preferred embodiment of the present invention.

FIG. 2 is a schematic plan view of a busbar unit according to an example preferred embodiment of the present invention.

FIG. 3 is a schematic side cross-sectional view of the busbar unit according to an example preferred embodiment of the present invention.

FIG. 4 is a schematic plan view of a busbar according to an example preferred embodiment of the present invention.

FIG. 5 is a schematic perspective view of a busbar terminal according to an example preferred embodiment of the present invention.

FIG. 6 is a schematic side view of the busbar terminal according to an example preferred embodiment of the present invention.

FIG. 7 is a schematic perspective view of a stator according to an example preferred embodiment of the present invention.

FIG. 8 is a schematic enlarged view of the stator according to an example preferred embodiment of the present invention.

### DETAILED DESCRIPTION OF THE PREFERRED EMBODIMENTS

Hereinafter, preferred embodiments of the present invention will be described with reference to the accompanying drawings.

### First Preferred Embodiment

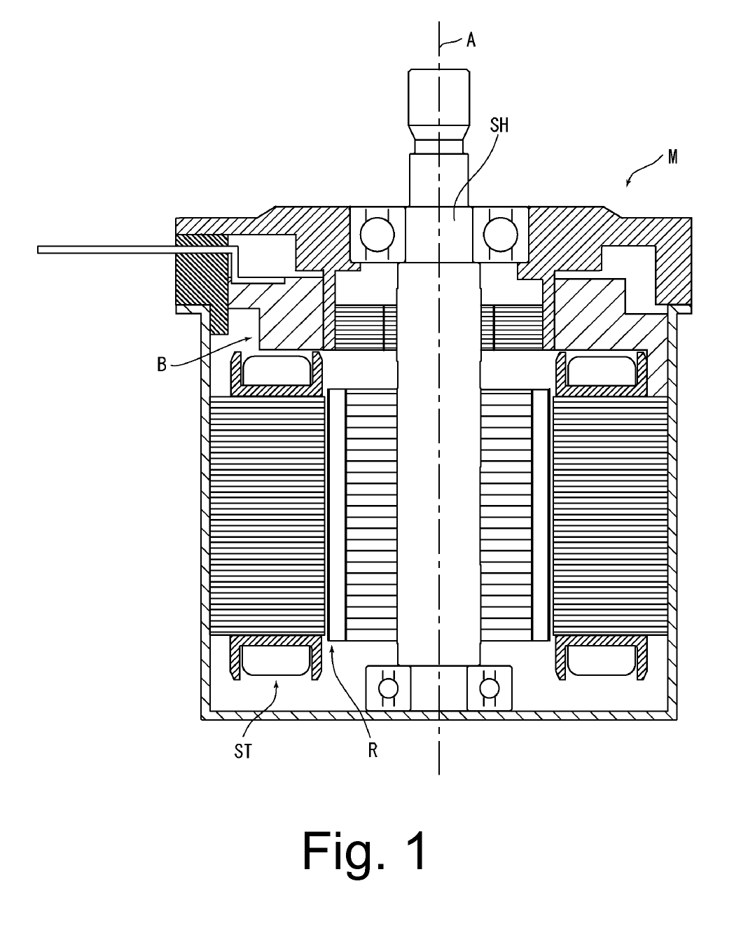

FIG. 1 is a schematic side cross-sectional view of a brushless motor M according to a first preferred embodiment of the present invention. The brushless motor M preferably includes a stator ST, a rotor R, a shaft SH, and a busbar unit B.

The brushless motor M may be placed in various orientations in accordance with usage conditions. However, for the sake of convenience in description, it is assumed in the following description that an upper side and a lower side along a direction parallel or substantially parallel to a rotation axis A as illustrated in FIG. 1 are defined as an upper side and a lower side, respectively, along an axial direction. It is also assumed that, along directions perpendicular or substantially perpendicular to the rotation axis A, positions closer to the rotation axis A and positions farther from the rotation axis A are defined as an inner side and an outer side, respectively, along a radial direction, and that a direction about the rotation axis A is defined as a circumferential direction.

The stator ST preferably includes a plurality of teeth. Each of the plurality of teeth has a conductor wire wound thereon, and the stator ST is arranged to generate a rotating magnetic field when a drive current is supplied to the conductor wires.

The rotor R preferably includes a rotor magnet arranged to have multiple magnetic poles. The rotor R is arranged to rotate about the rotation axis A integrally with the shaft SH upon the generation of the rotating magnetic field by the stator ST.

The busbar unit B is arranged to electrically connect the stator ST and a power supply (not shown) to each other. The busbar unit B is preferably arranged substantially on the upper side of the stator ST in the axial direction.

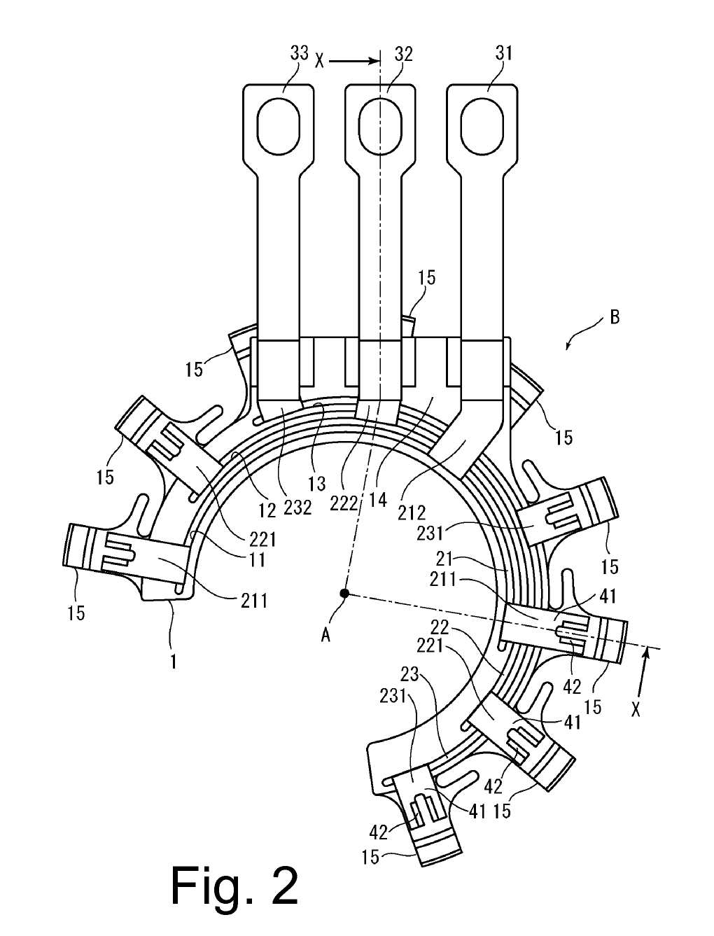

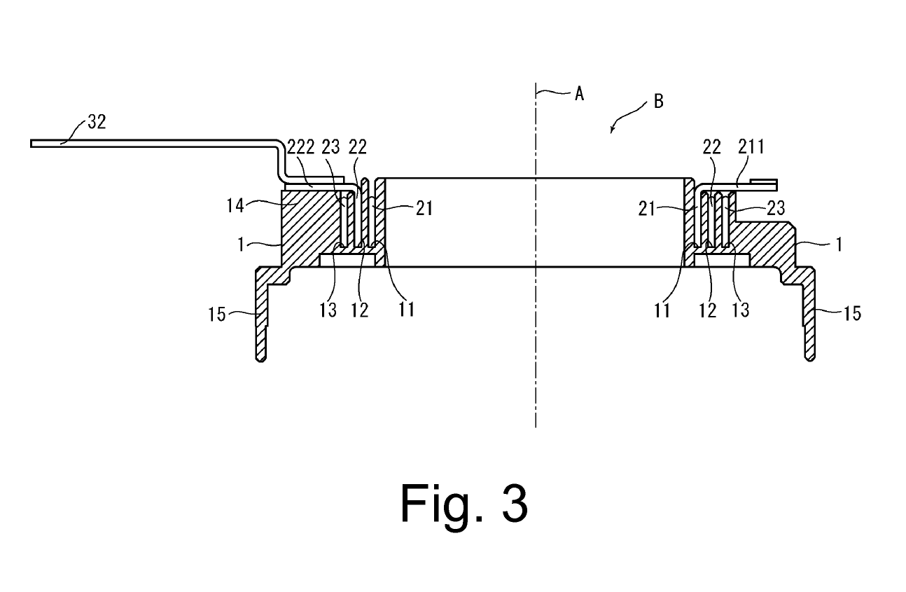

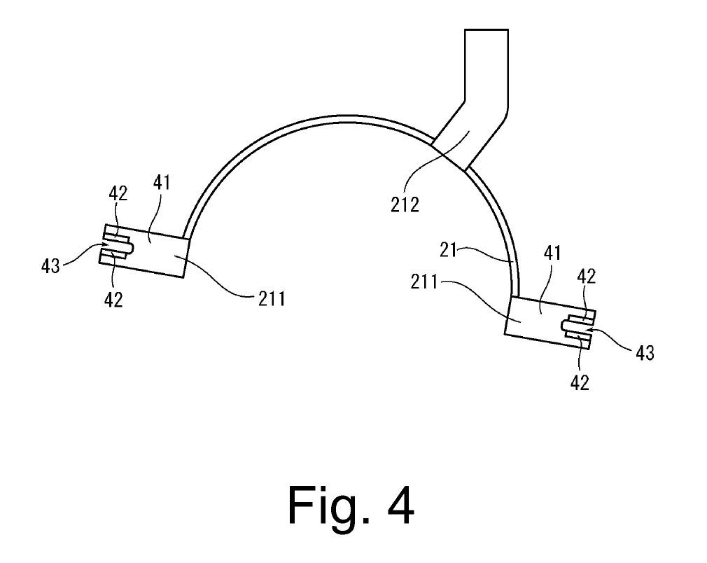

Next, the busbar unit B according to this preferred embodiment will now be described below with reference to FIGS. 2, 3, and 4. FIG. 2 is a schematic plan view of the busbar unit B as viewed from above in the axial direction. FIG. 3 is a schematic side cross-sectional view of the busbar unit B taken along arrowed line X-X shown in FIG. 2. FIG. 4 is a schematic plan view of a busbar 21 described below, as viewed from above in the axial direction. The busbar unit B includes a busbar holder 1 and busbars 21, 22, and 23.

The busbar holder 1 is defined by an insulating member substantially having the shape of a cylinder centered on the rotation axis A. The busbar holder 1 has grooves 11, 12, and 13 defined therein. The busbar holder 1 includes a support portion 14 and a fixing portion 15.

Each of the grooves 11, 12, and 13 includes a space defined substantially on the upper side of the busbar holder 1 in the axial direction. Of the grooves 11, 12, and 13, the groove 11 is defined at an innermost position in the radial direction, the groove 13 is defined at an outermost position in the radial direction, and the groove 12 is defined at a position between the grooves 11 and 13 in the radial direction. The grooves 11, 12, and 13 are arranged to accommodate the busbars 21, 22, and 23, respectively.

A support portion 14 is arranged to project substantially radially outward. The support portion 14 is arranged to support power supply connection portions 212, 222, and 232 described below.

The fixing portion 15 is preferably arranged to project substantially axially downward. The fixing portion 15 is arranged to fix the busbar unit B substantially on the upper side of the stator ST in the axial direction.

Each of the busbars 21, 22, and 23 is an electrically conductive member substantially in the shape of a semicylinder centered on the rotation axis A. The busbar 21 includes busbar terminals 211 and the power supply connection portion 212 (see FIG. 4). The busbar 22 includes busbar terminals 221 and the power supply connection portion 222. The busbar 23 includes busbar terminals 231 and the power supply connection portion 232.

The busbar terminals 211, 221, and 231 are arranged to extend substantially radially outward from the busbars 21, 22, and 23, respectively. The conductor wires drawn from the stator ST are connected to the busbar terminals 211, 221, and 231.

The power supply connection portions 212, 222, and 232 are arranged to extend substantially radially outward from the busbars 21, 22, and 23, respectively. Lead terminals 31, 32, and 33 are connected to the power supply connection portions 212, 222, and 232, respectively. The lead terminals 31, 32, and 33 are arranged to electrically connect the power supply (not shown) and the stator ST to each other through the busbars 21, 22, and 23.

The brushless motor M according to this preferred embodiment of the present invention preferably is a three-phase brushless motor. Accordingly, each of the busbars 21, 22, and 23 arranged in the busbar unit B corresponds to a separate one of a U-phase, a V-phase, and a W-phase. The number of busbars in the busbar unit B can be adjusted in accordance with the desired number of phases of the brushless motor M if more or less than three phases are desired.

According to this preferred embodiment of the present invention, each of the busbars 21, 22, and 23 includes two busbar terminals to which the conductor wires drawn from the stator ST are connected. The number of busbar terminals, to which the conductor wires drawn from the stator ST are connected, in each of the busbars 21, 22, and 23 can be adjusted in accordance with the desired number of phases of the brushless motor M and the desired number of teeth.

The busbars 21, 22, and 23 according to this preferred embodiment of the present invention are arranged to overlap with one another in the radial direction. Note, however, that the busbars 21, 22, and 23 may be arranged to overlap with one another in the axial direction. In this case, it is possible to ensure mutual insulation between the busbars 21, 22, and 23 by manufacturing the busbar holder 1 through, for example, injection molding such that the busbars 21, 22, and 23 will be electrically isolated from one another. The manner of arranging the busbars 21, 22, and 23 may be determined in accordance with specifications of the brushless motor M.

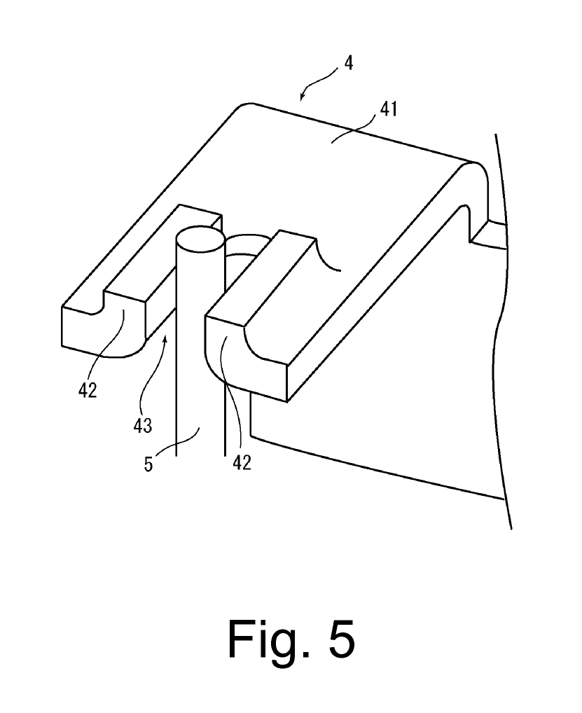

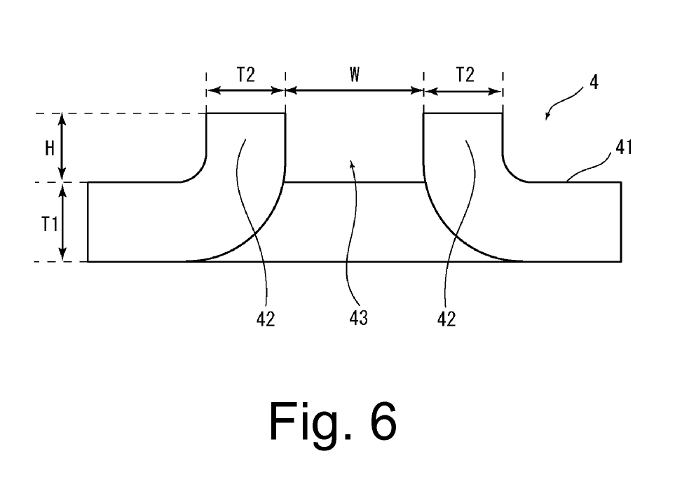

Next, the busbar terminals 211, 221, and 231 according to this preferred embodiment of the present invention will be described below with reference to FIGS. 5 and 6. In the following description, the busbar terminals 211, 221, and 231 will be referred to collectively as busbar terminals 4, since a structure common to all the busbar terminals 211, 221, and 231 will be described. FIG. 5 is a schematic perspective view of the busbar terminal 4. FIG. 6 is a schematic side view of the busbar terminal 4 as viewed from outside in the radial direction.

The busbar terminal 4 includes a terminal plate 41 and terminal walls 42. In actual practice, two conductor wires are connected to the busbar terminal 4. However, FIG. 5 only shows a single conductor wire 5 connected to the busbar terminal 4 for the sake of providing a simple illustration of a situation in which the conductor wires 5 are connected to the busbar terminal 4.

The terminal plate 41 is preferably a flat plate-shaped electrically conductive member spreading substantially perpendicularly to the axial direction. The terminal plate 41 has a through hole 43 defined at an outer edge thereof substantially in the radial direction. The through hole 43 is a space which allows the conductor wire 5, which is arranged on the stator ST, to pass through the terminal plate 41 in a direction parallel or substantially parallel to the axial direction.

Each terminal wall 42 is preferably a wall-shaped electrically conductive member arranged to rise from a periphery of the through hole 43 in a direction parallel or substantially parallel to the axial direction. The terminal wall 42 is an electrically conductive member which allows the conductor wire 5, which is drawn from the stator ST, to be connected to the busbar terminal 4.

The axial thickness of the terminal plate 41 is defined as T1, and the circumferential thickness of the terminal wall 42 is defined as T2. The axial height of the terminal wall 42 is defined as H. The circumferential width of the through hole 43 is defined as W. The circumferential width W of the through hole 43 is approximately equal to the diameter of the conductor wire 5.

Next, a preferred method for manufacturing the busbar terminal 4 will now be described below.

The busbar terminal 4 is preferably manufactured integrally through the use of a burring process. Note, however, that the busbar terminal 4 may be manufactured integrally by a method other than the burring process, such as, for example, a bending process or any other desired manufacturing process.

First, a pilot hole is formed substantially at the outer edge, in the radial direction, of the terminal plate 41, in which neither the terminal walls 42 nor the through hole 43 has been formed yet. The circumferential width of the pilot hole is determined to be smaller than the circumferential width W of the through hole 43. The circumferential width of the pilot hole is determined appropriately in accordance with desired values of W, H, and T2.

Second, the burring process is performed on the terminal plate 41 in which the pilot hole has been formed, substantially at the outer edge thereof in the radial direction. Specifically, a burring punch is pressed against the terminal plate 41 from above in the axial direction, so that edges of a die push a periphery of the pilot hole upward in the axial direction, resulting in formation of the terminal walls 42.

The busbar terminal 4 with the example measurements illustrated in FIG. 6 is manufactured integrally by the method described above.

Next, a method of connecting the conductor wire 5 to the busbar terminal 4 will now be described below.

First, the conductor wire 5 is inserted into the through hole 43 from below in the axial direction. The direction in which the conductor wire 5 is inserted into the through hole 43 is the same as, and not opposite to, the direction in which the terminal walls 42 are arranged to rise from the periphery of the through hole 43. Therefore, it is easy to insert the conductor wire 5 into the through hole 43.

Second, the conductor wire 5 is preferably welded to circumferentially inner surfaces of the terminal walls 42 to thereby connect the conductor wire 5 to the busbar terminal 4 through fusion joining. Accordingly, a secure connection of the conductor wire 5 to the busbar terminal 4 can be achieved.

The busbar terminal 4 as illustrated in FIG. 5 is preferably manufactured by the method described above.

Here, examples of burring processes include an ordinary burring process and an ironing-involving burring process, i.e., a burring process that involves an ironing process. In the case of the ordinary burring process, the relationship T1=T2 is applied. In the case of the ironing-involving burring process, the relationship T1>T2 is applied.

Suppose that a busbar terminal 4 having equal values of W and T1 is manufactured by either the ordinary burring process or the ironing-involving burring process. In this case, the busbar terminal 4 manufactured by either of the burring processes will include a terminal plate 41 with an equal axial thickness, and allow a conductor wire 5 with an equal diameter to pass therethrough.

In both the ordinary burring process and the ironing-involving burring process, the circumferential width of the pilot hole is determined to be smaller than the circumferential width W of the through hole 43. Therefore, use of either burring process to manufacture the busbar terminal 4 achieves a reduction in an unnecessary portion that does not form a portion of the busbar terminal 4.

In both the ordinary burring process and the ironing-involving burring process, the value of H is determined to be a non-zero finite value. Therefore, regardless of by which burring process the busbar terminal 4 is manufactured, it is possible to weld the conductor wire 5 to the circumferentially inner surfaces of the terminal walls 42. Moreover, even in the case where the motor M is to be placed in severe usage conditions, the connection between the busbar terminal 4 and the conductor wire 5 is sufficiently secure.

The value of T2 will be smaller in the case of the ironing-involving burring process than in the case of the ordinary burring process. Therefore, when the busbar terminal 4 is manufactured by the ironing-involving burring process, it is easier to weld the conductor wire 5 to the circumferentially inner surfaces of the terminal walls 42.

The value of H will be greater in the case of the ironing-involving burring process than in the case of the ordinary burring process. Therefore, when the busbar terminal 4 is manufactured by the ironing-involving burring process, the conductor wire 5 can be welded to the circumferentially inner surfaces of the terminal walls 42 more securely. Even in the case where the motor M is to be placed in severe usage conditions, the busbar terminal 4 is capable of more secure connection with the conductor wire 5.

The busbar terminal 4 according to this preferred embodiment of the present invention has a through hole 43 which is provided substantially in the shape of a rectangle as viewed in the axial direction and which is open at the outer edge thereof substantially in the radial direction defined therein. Note, however, that the through hole 43 defined in the busbar terminal 4 may also be substantially in the shape of a circle as viewed in the axial direction, and be closed at the outer edge thereof substantially in the radial direction if so desired. In this case, the diameter of the through hole 43, which is substantially in the shape of a circle, is approximately equal to the diameter of the conductor wire 5.

Both the method of manufacturing the busbar terminal 4 and the method of connecting the conductor wire 5 to the busbar terminal 4 are substantially the same whether the through hole 43 defined in the busbar terminal 4 is substantially in the shape of a circle or whether the through hole 43 defined in the busbar terminal 4 is substantially in the shape of a rectangle.

The area of the pilot hole can be smaller in the case where the through hole 43 defined in the busbar terminal 4 is substantially in the shape of a circle than in the case where the through hole 43 defined in the busbar terminal 4 is substantially in the shape of a rectangle. Therefore, in the former case, it is possible to achieve an additional reduction in the unnecessary portion that does not form a portion of the busbar terminal 4.

In the case where the through hole 43 defined in the busbar terminal 4 is substantially in the shape of a circle, it is possible to weld the conductor wire 5 to the terminal wall 42 at an entire circumference of the conductor wire 5. In the case where the through hole 43 defined in the busbar terminal 4 is substantially in the shape of a rectangle, it is possible to weld the conductor wire 5 to the terminal walls 42 only at portions of the entire circumference of the conductor wire 5. Therefore, it is possible to weld the conductor wire 5 to the terminal wall(s) 42 more securely in the former case than in the latter case.

### Second Preferred Embodiment

Next, a second preferred embodiment will be described below. A brushless motor M according to this preferred embodiment of the present invention is preferably a three-phase brushless motor having a Wye connection, and includes components similar to those of the brushless motor M described above with reference to FIG. 1. The brushless motor M according to this preferred embodiment of the present invention includes a neutral point busbar terminal 6, which is similar to the busbar terminal 4 described above with reference to FIGS. 5 and 6, as a neutral point busbar terminal which forms a neutral point of the Wye connection.

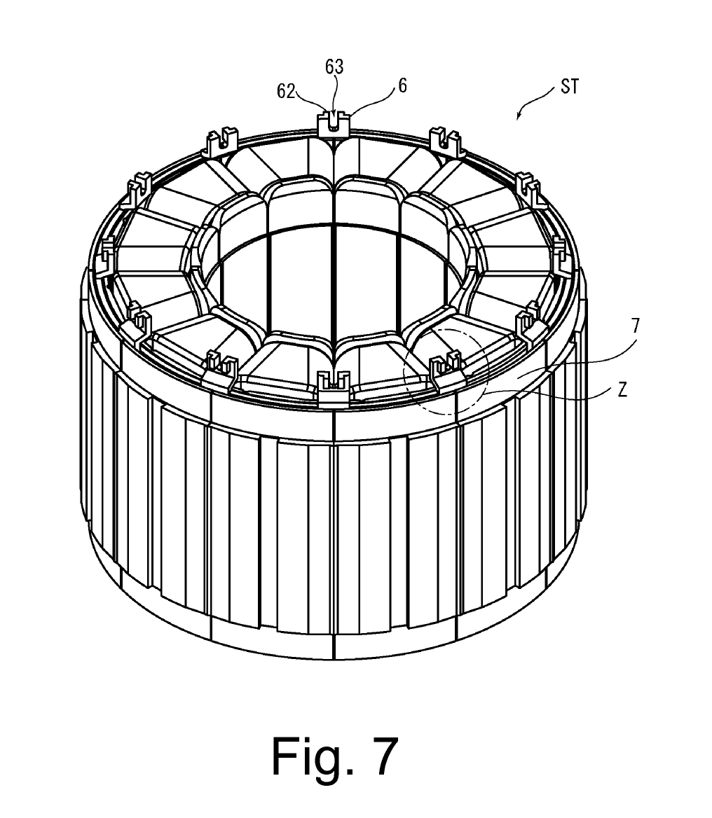

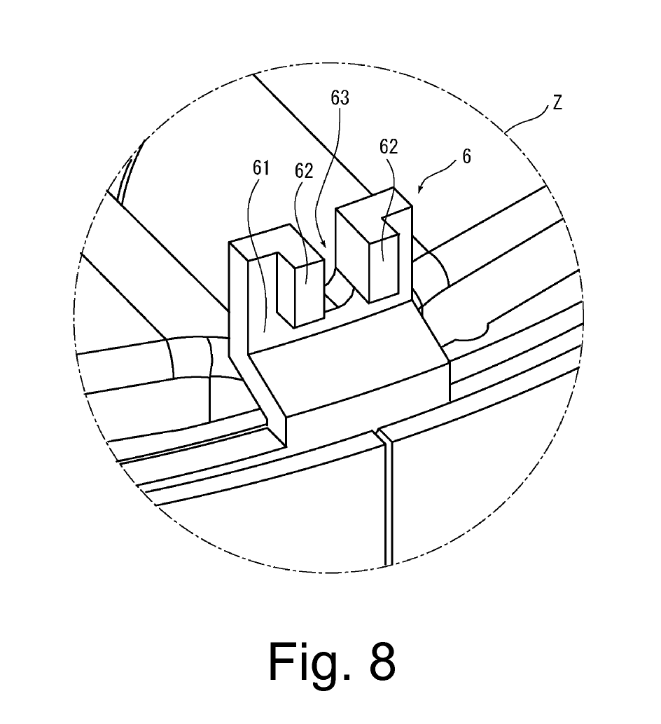

FIG. 7 is a schematic perspective view of a stator ST. FIG. 8 is a schematic enlarged view thereof illustrating area Z shown in FIG. 7. Teeth are covered by an insulator 7, which is preferably an insulating member made of, for example, a resin. A neutral point busbar is arranged substantially on an upper side of the insulator 7 in the axial direction. The neutral point busbar terminal 6 is arranged to extend substantially upward in the axial direction from the neutral point busbar. The neutral point busbar terminal 6 includes a terminal plate 61 and terminal walls 62.

The terminal plate 61 is preferably a flat plate-shaped electrically conductive member extending substantially in the axial direction. The terminal plate 61 has a through hole 63 defined at an upper edge thereof in the axial direction. The through hole 63 is a space which allows a conductor wire arranged at the neutral point to pass through the terminal plate 61 in a direction parallel or substantially parallel to the radial direction.

Each terminal wall 62 is a wall-shaped electrically conductive member arranged to rise from a periphery of the through hole 63 in a direction substantially parallel to the radial direction. The terminal wall 62 is an electrically conductive member which allows the conductor wire arranged at the neutral point to be connected to the neutral point busbar terminal 6.

The number of neutral point busbar terminals can be adjusted in accordance with the number of phases of the brushless motor M and the number of teeth. A method of manufacturing the neutral point busbar terminal 6 is similar to the method of manufacturing the busbar terminal 4. A method of connecting the conductor wire to the neutral point busbar terminal 6 is similar to the method of connecting the conductor wire to the busbar terminal 4.

An effect produced by the neutral point busbar terminal 6 is similar to the effect produced by the busbar terminal 4. That is, the neutral point busbar terminal 6 is capable of connection with the conductor wire while achieving a reduction in an unnecessary portion that does not form a portion of the neutral point busbar terminal 6.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A busbar terminal to which a conductor wire arranged to supply a drive current to an armature of a motor is connected, the busbar terminal comprising:
a terminal plate including a through hole defined therein and arranged to allow the conductor wire to pass therethrough; and
a terminal wall arranged to rise above the terminal plate from a periphery of the through hole.

12. The busbar terminal according to claim 11, wherein the terminal plate and the terminal wall are arranged integrally with each other by a burring process performed on the periphery of the through hole.

13. The busbar terminal according to claim 11, wherein a thickness of the terminal wall is smaller than a thickness of the terminal plate.

14. The busbar terminal according to claim 11, wherein the conductor wire is welded to the terminal wall.

15. The busbar terminal according to claim 11, wherein the conductor wire is inserted through the through hole in a same direction in which the terminal wall is arranged to rise above the terminal plate from the periphery of the through hole.

16. A busbar unit comprising:
a busbar or busbars each including the busbar terminal according to claim 11; and
a busbar holder arranged to hold the busbar or busbars.

17. The busbar unit according to claim 16, wherein
the busbar or busbars include a plurality of separate busbars;
the busbar holder arranged to hold the plurality of separate busbars; and
the plurality of separate busbars are arranged to overlap with one another in a radial direction of the busbar holder.

18. The busbar unit according to claim 16, wherein
the busbar or busbars include a plurality of separate busbars;
the busbar holder is arranged to hold the plurality of separate busbars; and
the plurality of separate busbars are arranged to overlap with one another in an axial direction of the busbar holder.

19. A motor comprising the busbar unit according to claim 16.

20. The motor according to claim 19, wherein
the motor is a three-phase brushless motor including a Wye connection between a plurality of the conductor wires; and
the busbar or busbars include a neutral point busbar which defines a neutral point of the Wye connection.

21. The motor according to claim 20, wherein
the busbar holder includes an insulator arranged to support the plurality of conductor wires on a stator of the three-phase brushless motor.
